(19) United States
(12) Patent Application Publication
(10) Pub. No.: US 2026/0337081 A1
(43) Pub. Date: Oct. 29, 2026

(54) METHOD FOR MANUFACTURING GLASS, AND HYBRID GLASS FURNACE FOR IMPLEMENTING THE MANUFACTURING METHOD

(71) Applicant: SAINT-GOBAIN ISOVER, COURBEVOIE (FR)

(72) Inventors: Thibault GUILLET, SOLLENTUNA (SE); Richard CLATOT, AUBERVILLIERS (FR); Guillaume GIMENEZ, AUBERVILLIERS (FR)

(21) Appl. No.: 19/110,682

(22) PCT Filed: Sep. 13, 2023
(86) PCT No.: PCT/EP2023/075200

§ 371 Date: Mar. 11, 2025

(30) Foreign Application Priority Data
Sep. 14, 2022 (FR) 2209219

(51) Int. Cl. C03B 5/03; C03B 5/00; C03B 5/235

(52) U.S. Cl. CPC C03B 5/03; C03B 5/005; C03B 5/2356

(57) ABSTRACT

A method for manufacturing glass includes melting vitrifiable materials containing a proportion of carbon-containing organic matter between 0.5% and 10%, wherein the melting is implemented by a hybrid glass furnace including a hot-top tank including from upstream to downstream a first heating zone including a combustion heater; a second heating zone including electrodes immersed in the bath of molten materials, the melting being implemented such that the proportion of combustion energy used for melting vitrifiable materials in the first zone is at least 50% and the proportion of electrical energy used for melting vitrifiable materials in the second zone is at least 50%, prioritizing the use of the combustion energy in the first heating zone to limit foaming in this first heating zone and, conversely, the use of the electrical energy in the second heating zone to maximize the heating efficiency of each of the energies used in the furnace.

### PRIOR ART

The present invention belongs to the general field of manufacturing glass. More particularly, it concerns a manufacturing method comprising a step of melting vitrifiable materials so as to be able to manufacture glass. It also relates to a hybrid glass furnace configured to implement said manufacturing method. The invention finds a particularly advantageous, although by no means limiting, application in the case where the glass to be produced is a borosilicate glass.

In the present description, “vitrifiable materials” is understood to mean all materials, natural ores or synthesized products, materials derived from recycling such as cullet, etc. which can enter the composition that feeds a glass furnace intended for manufacturing glass.

Likewise, “glass” is understood to mean glass in the broad sense, that is, encompassing any material with a vitreous, glass-ceramic or ceramic matrix.

In addition, the term “manufacturing” comprises the indispensable step of melting the vitrifiable materials and, if necessary, all the subsequent steps of refining/conditioning the molten glass for its final shaping, in particular in the form of flat glass (glazings), hollow glass (bottles, jars), glass in the form of mineral wool (in particular rock wool or glass wool) used for its thermal or sound insulation properties, or even optionally glass in the form of textile yarns used in reinforcement.

Various examples of furnace designs for melting vitrifiable materials are known to the state of the art, so as to obtain a bath of molten materials, also commonly referred to as a “batch mixture” or “composition”, from which glass can be manufactured. More specifically, and in particular to meet the ecological challenge of reducing carbon dioxide (CO₂) emissions, it is known to use a fuel-fired furnace (via burners) using electric auxiliary heating (via electrodes embedded in the bath). A furnace of this design thus combines several energies, respectively a combustion energy, for example of fossil origin (generally gas), and an electrical energy. Such a furnace is also known as a “hybrid” glass furnace.

A conventional hybrid glass furnace comprises a hot-top tank, which is divided (virtually or physically by means of a suitable vertical wall) into two heating zones. The term “heating zones” refers to parts of the tank, distributed from upstream to downstream with reference to the direction of flow of the vitrifiable materials introduced into the tank, and differing from one another in terms of the proportion of combustion energy (or electrical energy, respectively) used to heat the vitrifiable materials.

More specifically, the current design of a hybrid glass furnace tank consists in having an upstream heating zone designed to melt the vitrifiable materials and mainly supplied with electrical energy, and a downstream heating zone designed more for refining the glass composition (that is, improving the quality of the glass so that it contains as few unmelted particles as possible, or as few bubbles as possible) and mainly supplied with combustion energy.

This design optimizes heating efficiency (or heat transfer) in both the upstream and downstream heating zones of the hybrid glass furnace. Electrical energy is also preferred in the upstream heating zone for melting vitrifiable materials, as around 99% of the power is transmitted to the glass bath via the electrodes. By comparison, the power transmitted to the vitrifiable materials by burners in the upstream heating zone is much lower, around 60%, depending on the fuel/oxidizer mixture, in particular the oxygen content and/or the use of preheating. This is one of the reasons why this type of hybrid glass furnace has become the benchmark for glass production.

During operation, the appearance of a “foaming” phenomenon on the surface of the molten bath is conventionally observed in a glass furnace. The presence of this foam is due in particular to the contents of the vitrifiable materials. For recycling purposes, they typically contain used materials such as household or flat cullet and/or glass wool (e.g. glass wool waste from a production line or end-of-life products). These used materials do, however, contribute to increasing the proportion of carbon chains (organic pollution on bottle cullet, for example, or binder in mineral wool) and sulfate in the bath. However, especially in the vicinity of electrodes, but not exclusively, the foaming phenomenon is thermally activated, and the sulfate desolubilizes by reacting with the added carbon, thus generating the foam in question.

The inventors have demonstrated that the foam forms a thermal shield that is particularly detrimental to the overall heating efficiency of such a hybrid glass furnace, for the reasons detailed below.

In the upstream heating zone, where foam formation is encouraged due to the predominant use of electrical energy for heating, the foam forms a thermal shield at the interface between the glass bath and the floating vitrifiable materials that have not yet melted. As a result, this thermal shield limits the transfer of heat generated by the electrodes to the vitrifiable materials newly introduced onto the surface of the glass bath. Those materials are therefore only partially melted in the tank, making tonnage management more complex and increasing the risk of bath overflow outside the tank.

Foam may also be present in the downstream heating zone. This may be due to foam transfer from the upstream zone and/or to the presence of unmelted particles from the upstream heating zone, which sustains the foaming phenomenon, and/or to the high temperatures reached in this downstream zone. Insofar as combustion energy is used predominantly there, the problem of heat transfer from the burners to the bath is a major one. The foam forms a thermal shield between the burners and the glass bath that is to be heated and refined in said downstream heating zone.

A non-limiting example is given below to show the consequences of the shielding resulting from the presence of foam, which forms said thermal shield. In the case of overhead burners, for a power input of 200 kW/m², it is estimated that around 40 kW/m² (plus or minus +/−10 kW/m²) will be transferred to the glass bath in the presence of foam forming said thermal shield, whereas the power input is, by comparison, around 120 kW/m² (plus or minus +/−10 kW/m²) for vitrifiable materials present on the surface of the glass bath. In the case of electrodes, for a power input of 200 kW/m², we know that around 198 kW/m² will be transferred to the glass bath (which is due to the above-mentioned design of the glass hybrid furnace), but we estimate that only around 40 kW/m² (more or less +/−10 kW/m²) will be transferred to the glass materials to be melted that are present on the bath surface, again due to the thermal shield formed by the foam.

Thus, limiting the overall heating efficiency of the hybrid furnace means that the foaming phenomenon is an obstacle to the use of cullet and/or glass wool-based products as vitrifiable materials, that is, for recycling. In other words, foaming limits the recycling capacity of a hybrid furnace and leads to a significant increase in energy consumption, or even a rise in temperature that contributes to premature wear of the furnace refractories.

Current attempts to alleviate this foaming problem are far from optimal, as they involve countermeasures such as the addition of solid oxidizers like sodium nitrate (NaNO₃) and manganese oxide (MnO₂). Indeed, the use of oxidants is itself limited, in particular by NOx emissions and the need to maintain a glass target that is notably biosoluble. Consequently, an increase in the quantity of oxidants is not feasible, leading to a de facto limit of recycling in vitrifiable materials.

It should be noted that the foaming phenomenon described above, although present whatever the composition of the vitrifiable materials, is more particularly problematic (in terms of the quantity of foam generated) when the glass to be manufactured is borosilicate glass.

### OVERVIEW OF THE INVENTION

The aim of the present invention is to remedy some or all of the disadvantages of the prior art, in particular those disclosed above, by proposing a solution that maximizes the heating efficiency (or heat transfer) of each of the energies used (combustion, electrical) as well as the recycling capacity within a hybrid furnace.

To this end, and according to a first aspect, the invention relates to a method for manufacturing glass, the method comprising a step of melting vitrifiable materials that are intended for the manufacture of said glass, said vitrifiable materials containing a proportion of carbon-containing organic matter of between 0.5% and 10%, wherein the step of melting the vitrifiable materials is implemented by means of a hybrid glass furnace comprising a hot-top tank, the tank comprising, from upstream to downstream:
a first heating zone comprising combustion heating means,
a second heating zone comprising electrodes immersed in the bath of molten materials,
   the melting step being implemented such that the proportion of combustion energy used for melting vitrifiable materials in the first zone is at least 50% and the proportion of electrical energy used for melting vitrifiable materials in the second zone is at least 50%, prioritizing the use of the combustion energy in the first heating zone in order to limit foaming in this first heating zone and, conversely, the use of the electrical energy in the second heating zone so as to maximize the heating efficiency of each of the energies used in the furnace.

Advantageously, the prioritization of combustion energy in the first heating zone and, conversely, electrical energy in the second heating zone during the melting step is determined as a function of the proportion of carbonaceous organic matter contained in the vitrifiable materials.

According to one important feature, the method for manufacturing glass according to the invention is that it involves, for the person skilled in the art, a paradigm shift in the design of the glass furnace used for its implementation. Indeed, as described above, the design of the hybrid glass furnace according to the prior art was based on the principle of using electrical energy in the upstream heating zone and combustion energy in the downstream heating zone, due to the efficiency of the heat transfer respectively obtained.

Thus, the person skilled in the art is dissuaded from modifying such a furnace design, especially when the implementation of the invention leads that person to using electrical and combustion energies in the heating zones of the tank, which counter-intuitively inverts the dominant energy in each, that is, the totally opposite case.

The manufacturing method according to the invention therefore makes it possible to prioritize the use of combustion energy in the first heating zone, and, conversely, to prioritize the use of electrical energy in the second heating zone.

This greatly reduces the risk of the sulfate contained in the vitrifiable materials interacting with the carbon chains also contained in the vitrifiable materials, avoiding the presence of localized spots within the glass that are very hot. In other words, doing so advantageously limits foaming in the first heating zone.

Furthermore, if foam does form, the main heating means (burners or electrodes) in each zone is not separated from what it is meant to heat by a layer of foam forming a thermal screen, that is, the screening or thermal screen previously present in the prior art.

As a result, the invention maximizes the heating or heat transfer efficiency of each of the energies used in the furnace. In fact, as the appearance of foam is greatly limited in the first heating zone, so is the problem of poor heat transfer between the bath and the vitrifiable materials, which greatly encourages the melting of the vitrifiable materials introduced into the tank.

In the second heating zone, where the energy used is predominantly electrical, the glass bath is virtually free of carbonaceous vitrifiable materials and sulfate, so that electrical heating is highly efficient without the risk of poor heat transfer.

What's more, if a foam residue does form on the bath surface in the second heating zone, this will have no deleterious effect on glass production. Rather, this foam residue forms a thermal shield against the heat generated underneath the bath surface by the electrodes, contributing to the good thermal insulation of said bath. The thermal shield formed by the foam, which was previously a disadvantage in the second heating zone with burners, becomes an advantage with electrodes.

In particular embodiments, the melting method may further comprise one or more of the following features, taken in isolation or according to any of the technically possible combinations.

In particular embodiments, the proportion of combustion energy used to melt vitrifiable materials in the first zone is at least 60%, and the proportion of electrical energy used to melt vitrifiable materials in the second zone is at least 60%.

In particular embodiments, the proportion of combustion energy used in the first zone is at least 70%.

In particular embodiments, the melting energy used in the first zone is solely combustion energy.

In particular embodiments, the first heating zone further comprises electrodes immersed in the bath of molten material, the melting step being implemented so that the proportion of electrical energy used in the first zone enables the bath temperature to be maintained above a given temperature, for example a glass devitrification temperature.

In particular embodiments, the proportion of electrical energy used in the second zone is at least 70%.

In particular embodiments, the melting energy used in the second zone is solely electrical energy.

In particular embodiments, the second heating zone further comprises combustion heating means, the melting step being implemented in such a way that the proportion of combustion energy used in the second zone enables the temperature of the crown to be maintained above a given temperature, for example a sodium borate condensation temperature.

In particular embodiments, the proportion of combustion energy used in the first zone and the proportion of electrical energy used in the second zone are equal.

In particular embodiments, the proportion of combustion energy used in the first zone and the proportion of electrical energy used in the second zone are different, one being greater than the other, or vice versa.

In particular embodiments, the combustion energy in the first and/or second zone is obtained by burning hydrogen.

In particular embodiments, the vitrifiable materials are chosen to enable the manufacture of borosilicate glass.

In particular embodiments, the proportion of carbonaceous organic matter contained in the vitrifiable materials, less than or equal to 10%, is between 0.75% and 10%, more preferentially between 1% and 10%, even more preferentially between 2% and 10%.

In particular embodiments, the vitrifiable materials comprise recycled materials, such as cullet, for example in a proportion less than or equal to 90%, and/or mineral wool in a proportion less than or equal to 100%.

In particular embodiments, the combustion fumes produced in the first heating zone are discharged towards the second heating zone as far as an exhaust chimney arranged downstream in said second heating zone so as to enable the temperature of the crown in said second heating zone to be maintained above a given temperature, in particular a sodium borate condensation temperature, by means of said fumes.

According to a second aspect, the invention relates to a hybrid glass furnace configured to implement a method for manufacturing glass, said furnace comprising a control unit for respectively controlling at least the combustion heating means in the first heating zone and the electrodes immersed in the bath of molten materials in the second heating zone as a function of the proportion of carbonaceous organic matter contained in the vitrifiable materials, prioritizing the use of the combustion energy in the first heating zone in order to limit foaming in this first heating zone and, conversely, the use of the electrical energy in the second heating zone so as to maximize the heating efficiency of each of the energies used in the furnace.

In particular embodiments, the hybrid glass furnace may further comprise one or more of the following features, taken alone or in any technically feasible combinations.

In particular embodiments, the furnace comprises a vertical partition configured to:
block the flow of melt between the first and second zones on the surface of the bath of molten materials,
allow melt to circulate between the first and second zones at the hearth of the furnace.

The ability of the partition (due to its adapted height) to block, at the surface of the bath of molten materials, the circulation of molten materials between the zones advantageously prevents foam generated in the second heating zone from migrating to the first heating zone. In other words, the presence of the vertical partition further optimizes the heating efficiency of the hybrid furnace.

In particular embodiments, the crown height in the second heating zone is lower than the crown height in the first heating zone.

In particular embodiments, the bath height in the second heating zone is lower than the bath height in the first heating zone.

In particular embodiments, the furnace further comprises an exhaust chimney which, arranged in a downstream portion of the second heating zone, is configured to discharge combustion fumes produced in the first heating zone to the second heating zone.

### BRIEF DESCRIPTION OF THE DRAWINGS

Other features and advantages of the present invention will emerge from the non-limiting description given below, with reference to the appended drawings that illustrate an exemplary embodiment thereof. In the figures:

FIG. 1 schematically shows a particular embodiment of a hybrid glass furnace according to the invention;

FIG. 2 schematically shows another embodiment of a hybrid glass furnace according to the invention;

FIG. 3 schematically shows yet another embodiment of a hybrid glass furnace according to the invention;

FIG. 4 schematically shows yet another embodiment of a hybrid glass furnace according to the invention;

FIG. 5 schematically shows yet another embodiment of a hybrid glass furnace according to the invention.

### DESCRIPTION OF EMBODIMENTS

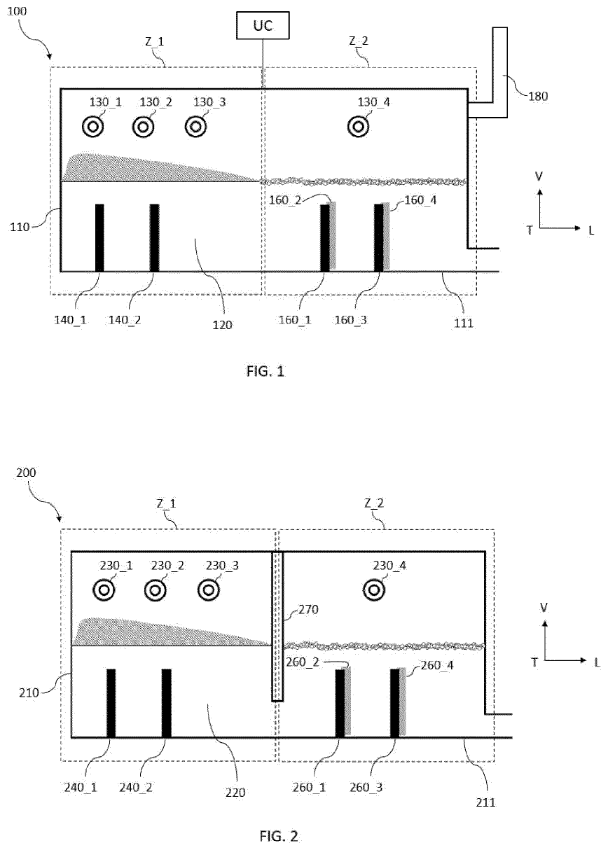

FIG. 1 schematically shows, in its environment, a particular embodiment of a glass furnace 100 according to the invention. In particular, FIG. 1 shows a side view of the furnace 100.

In the remainder of the description, the longitudinal, vertical, and transverse orientations will be used without limitation in reference to the axis system (L, V, T) shown in the figures.

By convention, the terms “upstream” and “downstream”, as well as “left” and “right”, are used in reference to the longitudinal orientation. The terms “upper” and “lower” or “top” and “bottom” or “above” and “below” are used in reference to the vertical orientation.

More particularly, in the present description, the terms “upstream” and “downstream” correspond to the direction of flow of the glass in the furnace, with the glass flowing from upstream to downstream, or, put another way, from left to right with regard to the depiction of the furnace 100 in FIG. 1.

In accordance with the invention, the furnace 100 comprises a hot-top tank 110, typically made of refractory material, for example Alumina Zirconia Silica or Chromium.

The concept of a “hot top” in a glassmaking furnace is well known to the person skilled in the art, so it is not explained further here. As a reminder, according to this design, vitrifiable materials are introduced into the tank 110 from the side (that is, along its longitudinal orientation), typically by means of a loading device (not shown in the figures), also known as a “loading machine”.

In the embodiment shown in FIG. 1, the tank 110 has a horizontally extending bottom wall 111, which forms the hearth of the furnace 100. Similarly, nothing precludes considering, according to other examples, a lower wall inclined relative to the horizontal, for example in the form of a cone pointing downward or else an inclined plane, so as to promote the driving of molten vitrifiable material toward the bottom of the tank 110 at the start of melting.

The furnace 100 is configured to melt the vitrifiable materials introduced into the tank 110 to form a bath 120 of molten vitrifiable material. The material thus melted is intended for the manufacture of glass, the furnace 100 being integrated, for this purpose, into a glass manufacturing installation comprising, in zones other than those where the furnace 100 is implemented, various devices (not shown in the figures) capable of implementing steps of refining and/or homogenization and/or thermal conditioning and/or final shaping of the glass. Such steps are well known to the person skilled in the art, so they are not described further here.

For the remainder of the description, it is considered in a non-limiting manner that the glass intended to be manufactured from the molten material in the furnace 100 is a borosilicate glass. Considering the manufacture of such a glass is, however, only one variant of the invention. Thus, in general, there is no limitation on the type of glass to be produced using the melt in the furnace 100 according to the invention.

It should be noted that the composition of the vitrifiable materials making it possible to manufacture a glass of the borosilicate type is well-known to the person skilled in the art and therefore not described in detail here. Of course, such an observation also applies to all other types of glass that can be manufactured according to the invention. In addition, aspects relating to the proportion of carbonaceous organic matter that can be contained in the vitrifiable materials used are described in greater detail later.

In accordance with the invention, the glass furnace 100 is of the hybrid type. In other words, the vitrifiable materials in the tank 110 are melted to form the bath 120 using two different energy sources, combustion energy and electrical energy respectively. Each of these energies is used by suitable heating means of a type known per se, namely:
overhead burners arranged between the furnace crown 110 and the surface of the bath 120 for combustion energy, and
electrodes, made of refractory material, such as molybdenum, and embedded in the bath 120 for electrical energy.

Combustion can be achieved in a known way by combining different types of fuel and oxidizer. Oxygen in the air is thus generally used as an oxidant, and this air can be enriched with oxygen to obtain oxygen-enriched air. Pure oxygen can even be used as an oxidizer in the special case of oxy-fuel combustion.

In terms of combustion, the fuel used is generally natural gas, or possibly other fossil fuels, such as petroleum products like heating oil.

Of course, the use of fossil fuels has a direct impact on the carbon footprint of glass production, particularly in terms of the carbon dioxide (CO₂) emissions generated by combustion. To improve this carbon balance, it is possible to use a green fuel as an alternative to fossil fuels, in particular biogas, a gas composed essentially of methane and carbon dioxide produced by methanization.

Alternatively, the fuel used in all or part of furnace 100 can be hydrogen (H2), which is advantageously carbon-free compared with biogas.

In its general principle, the hybrid furnace 100 differs from hybrid furnaces of the prior art in that the tank 110 comprises, from upstream to downstream, two heating zones, a first heating zone Z_1 and a second heating zone Z_2, configured to implement a melting step for vitrifiable materials of the glass manufacturing method according to the invention (not shown in the figures).

The step of melting vitrifiable materials intended for the manufacture of said glass, said vitrifiable materials containing a proportion of carbonaceous organic matter of between 0.5% and 10%, is carried out in such a way that:
the proportion of combustion energy used to melt vitrifiable materials in the first zone Z_1 is at least 50% (that is, the total melting energy used in the first zone Z_1 to melt vitrifiable materials comprises at least 50% combustion energy), and
the proportion of electrical energy used to melt vitrifiable materials in the second zone Z_2 is at least 50% (that is, the total melting energy used in the second zone Z_2 to melt vitrifiable materials comprises at least 50% electrical energy).

More specifically, in the embodiment described here, the two heating zones Z_1, Z_2 are in fluid communication, with no barriers between them.

Furthermore, each of said heating zones Z_1, Z_2 is advantageously configured to enable the use of combustion energy as well as electrical energy. As shown in FIG. 1, the first heating zone Z_1 comprises three overhead burners 130_1, 130_2, 130_3 and two electrodes 140_1, 140_2. The second heating zone Z_2, meanwhile comprises a single overhead burner 150 and four electrodes 160_1, 160_2, 160_3, 160_4.

The burners 130_1, 130_2, 130_3, 150 are so-called transverse burners, commonly so called because of their transverse arrangement, perpendicular to the flow of glass in the furnace 100.

In the embodiment shown in FIG. 1, the electrodes 140_1, 140_2, 160_1, 160_2, 160_3, 160_4 are so-called rising electrodes, commonly so-called because of their vertical arrangement from the bottom 111 of the tank 110. However, one or more of the electrodes could have a different orientation, such as an oblique one.

Considering such a number of burners and electrodes in each of the heating zones Z_1, Z_2 is, however, only one variant of the invention. Generally speaking, there is no limitation on the number of burners and electrodes in each heating zone, as long as the proportion of combustion energy (respectively electrical energy) used in the first zone Z_1 (respectively in the second zone Z_2) is at least 50%.

Implementing the melting step of such a method for manufacturing glass by means of the hybrid furnace 100 therefore makes it possible to prioritize the use of combustion energy in the first heating zone Z_1 in order to limit foaming in said first heating zone Z_1, and, conversely, to prioritize the use of electrical energy in the second heating zone Z_2, so as to maximize the heating efficiency (that is, heat transfer) of each of said energies used in the furnace 100.

This greatly reduces the risk of the sulfate contained in the vitrifiable materials desolubilizing in the vicinity of the electrodes of the first heating zone Z_1 and interacting with the carbon chains also contained in the vitrifiable materials. In other words, doing so advantageously limits foaming in the first heating zone Z_1, that is, the consequences of the thermal shield formed by said foam.

As a result, the invention maximizes the heating efficiency of each of the energies used in the furnace 100. In fact, as the appearance of foam is greatly limited in the first heating zone Z_1, so is the problem of poor heat transfer between the bath and the vitrifiable materials, which greatly encourages the melting of the vitrifiable materials introduced into the tank 110.

In accordance with the invention, the energy source (combustion or electrical) is advantageously never separated by foam from whatever it is meant to heat, thereby remedying the disadvantages of the prior art described in the preamble, caused by screening or a thermal screen formed by said foam.

In fact, the foam—at least limited in the first heating zone—does not rise up onto the vitrifiable materials to be melted, and thus no longer forms a thermal screen, so that the melting achieved according to the invention mainly by means of burners is no longer impacted. Similarly, in the second heating zone, where heating and refining are mainly carried out by means of electrodes, the possible presence of foam no longer acts as a thermal barrier to the (electrical) energy source, as was the case in the prior art with burners.

In the second heating zone Z_2, where the energy used is predominantly electrical, the bath 120 is virtually free of carbonaceous materials and sulfate, so that electrical heating is highly efficient without the risk of poor heat transfer. What's more, if a foam residue does form on the surface of the bath 120 in the second heating zone Z_2 (as shown, for example, in FIG. 1), this will have no deleterious effect on glass production. Rather, this foam residue forms a thermal shield against the heat generated underneath the bath surface 120 by the electrodes, contributing to the good thermal insulation of said bath 120.

In a more particular exemplary embodiment of the melting step, the proportion of combustion energy used to melt vitrifiable materials in the first zone is at least 60%, and the proportion of electrical energy used to melt vitrifiable materials in the second zone is at least 60%.

According to a more particular exemplary embodiment of the melting step, the proportion of combustion energy used in the first zone Z_1 is at least 70%, for example the proportion of combustion energy used in the first zone Z_1 is 75% or 85%.

The melting step can also be implemented in such a way that the proportion of electrical energy used in the first zone Z_1 enables the bath temperature there to be maintained above a given temperature, for example a glass devitrification temperature.

Generally speaking, there is no limit to the proportion of combustion energy used in the zone Z_1, as long as it is greater than or equal to 50%. So, for example, there's nothing to prevent the melting energy used in the first zone Z_1 from being solely combustion energy (that is, combustion energy proportion=100%). In this respect, it is understood that the presence of electrodes in the first heating zone Z_1 is not essential to the invention.

In the second heating zone Z_2, in addition to the above examples of the proportion of combustion energy used in the first heating zone Z_1, the proportion of electrical energy is at least 70%, for example the proportion of electrical energy used in the second zone Z_2 is 75% or 85%.

In a more specific embodiment, the melting step can also be carried out in such a way that the proportion of combustion energy used in the second zone Z_2 enables the temperature of the crown to be maintained above a given temperature.

By way of example, said temperature corresponds to a sodium borate condensation temperature of around 1200 °C. This compound is known for its corrosive properties, and for its ability to condense on the walls of the crown if the temperature above the bath 120 is not sufficient.

Generally speaking, there is no limit to the proportion of electrical energy used in the second zone Z_2, as long as it is greater than or equal to 50%. So, for example, there is nothing to prevent the melting energy used in the second zone Z_2 from being solely electrical energy (that is, electrical energy proportion=100%). In this respect, it is understood that the presence of burners in the second heating zone Z_2 is not essential to the invention.

In addition to, or as an alternative to, maintaining the temperature of the crown above a given temperature by modulating the combustion energy used in the second heating zone Z_2, the furnace may further comprise an exhaust chimney 180 configured to discharge combustion fumes produced in the first heating zone Z_1 to the second heating zone Z_2.

Advantageously, the chimney 180 is arranged or connected to the downstream part of the second heating zone Z_2. However, there is no limitation on the configuration (shape, geometry, arrangement) of said chimney 180, which can, for example, take the form of openings cut into the crown of the tank 110 to form a fume exhaust passage.

Such a chimney 180, via the discharging of fumes into the second zone Z_2, also makes it possible to maintain the temperature there above a given temperature, and can therefore also help avoid corrosion effects linked to sodium borate condensation on the crown of the furnace 100.

Advantageously, the circulation of fumes (from the first heating zone Z_1) through the second heating zone Z_2 before being discharged downstream via the chimney 180 enables a crown temperature to be maintained above a given temperature, such as that of sodium borate condensation, and may even enable the burner 130_4 to be dispensed with, which is then particularly conducive to lowering the crown height in the second heating zone Z_2 of the furnace 100.

As previously mentioned, the melting step of the method for manufacturing glass according to the invention maximizes the heating efficiency of each of the energies used in the furnace 100. As a result, the invention enables greater use of recycled materials than is the case with the state of the art, so as to maximize the recycling capacity of the furnace 100.

Thus, according to a particular embodiment of the melting step, the proportion of carbonaceous organic matter contained in the vitrifiable materials introduced into the tank 110 is less than or equal to 10%.

According to one important feature of the invention, the vitrifiable materials intended for manufacturing glass contain a proportion of carbonaceous organic matter of between 0.5% and 10%, preferentially between 0.75% and 10%, more preferentially between 1% and 10%, even more preferentially between 2% and 10%.

The vitrifiable materials intended for manufacturing glass may comprise recycled materials, such as cullet (e.g. household cullet, mill cullet, etc.), for example in a proportion less than or equal to 90%, and/or mineral wool in a proportion less than or equal to 100% (e.g. glassfill corresponding to 100% glass wool for recycling, which can contain up to 10% binder).

The furnace 100 comprises a control unit UC for respectively controlling the combustion heating means 130_1, 130_2, 130_3 in the first heating zone Z_1 and the electrodes 160_1, 160_2, 160_3, 160_4 immersed in the bath of molten materials 120 in the second heating zone Z_2 as a function of the proportion of carbonaceous organic matter contained in the vitrifiable materials.

Preferably and according to a first example, during the melting step, the proportion of combustion energy used to melt vitrifiable materials in the first heating zone Z_1 is 50%, and the proportion of electrical energy used to melt vitrifiable materials in the second heating zone Z_2 is 50%, when the vitrifiable materials contain a proportion of carbonaceous organic matter of the order of 0.5%. In other words, the share of combustion energy and the share of electrical energy are respectively equal to 50% in each of said heating zones Z_1; Z_2.

Alternatively, the proportion of combustion energy and the proportion of electrical energy are not equal, e.g. the proportion of combustion energy in the first heating zone Z_1 is 50% and the proportion of electrical energy in the second heating zone Z_2 is greater than 50%, e.g. 70% or even 100%.

Of course, the proportion of combustion energy in the first zone Z_1 could alternatively also be greater than the proportion of electrical energy in the second zone Z_2, in particular with an electrical energy proportion of 50% and a combustion energy proportion greater than 50%, for example equal to 70% or even 100%.

Preferably and according to a second example, during the melting step, the proportion of combustion energy used to melt vitrifiable materials in the first heating zone Z_1 is 75%, and the proportion of electrical energy used to melt vitrifiable materials in the second heating zone Z_2 is 75%, when the vitrifiable materials contain a proportion of carbonaceous organic matter of the order of 5%. In other words, the share of combustion energy and the share of electrical energy are in such a case respectively equal to 75% in each of said heating zones Z_1; Z_2.

Preferably, during the melting step, the proportion of combustion energy used to melt vitrifiable materials in the first heating zone Z_1 is 100%, and the proportion of electrical energy used to melt vitrifiable materials in the second heating zone Z_2 is 100%, when the vitrifiable materials contain a proportion of carbonaceous organic matter equal to 10%.

In other words, the share of combustion energy and the share of electrical energy are in such a case respectively equal to 100% in each of said heating zones Z_1; Z_2.

According to the variants just described for the first example, the share of combustion energy and the share of electrical energy can be different for the second example or the third example, one being greater than the other or vice versa, each of said shares of energy being at least 50%.

Thanks to the control unit UC, the furnace 100 can be controlled by prioritizing the use of combustion energy in the first heating zone Z_1 in order to limit foaming in said first heating zone Z_1, and, conversely, the use of electrical energy in the second heating zone Z_2 so as to maximize the heating efficiency (that is, heat transfer) of each of said energies used in the furnace 100.

In comparison with the design shown in FIG. 1, other designs shown in FIGS. 2 to 5 will be described below, wherein the control unit UC, or even the exhaust chimney, have not been shown, but only for the sake of simplicity. Of course, the furnace shown in FIGS. 2 to 5 may further comprise a control unit UC for controlling energy prioritization, or even an exhaust chimney for discharging combustion fumes.

The hybrid furnace according to the invention has been described up to now considering a particular geometry according to which no physical separation exists between the two heating zones Z_1, Z_2. However, other alternatives are also possible.

FIG. 2 schematically shows, in its environment, another particular embodiment of a glass furnace 200 according to the invention.

In a similar arrangement to that described with reference to FIG. 1, the hybrid furnace 200 comprises a tank 210 wherein vitrifiable materials intended for the manufacture of glass are melted to form a bath 220. More particularly, the tank 220 comprises two heating zones Z_1, Z_2 from upstream to downstream, the step of melting the vitrifiable materials being carried out by means of:
three overhead burners 230_1, 230_2, 230_3 and two electrodes 240_1, 240_2 in the first heating zone Z_1,
an overhead burner 250 and four electrodes 260_1, 260_2, 260_3, 260_4 in the second heating zone Z_2.

Furthermore, in this other embodiment, and as shown by way of non-limiting example by FIG. 2, the furnace comprises a vertical partition 270 configured to:
block the flow of melt between the first and second zones 220 on the surface of the bath of molten materials Z_1, Z_2,
allow the melt to circulate between the first and second zones Z_1, Z_2 at the hearth 211 of the furnace 200.

The vertical partition 270, for example, is made of refractory material, such as magnesia and/or chromium, or of the Alumina-Zirconia-Silica type (whether fused-cast or not).

Alternatively, the vertical partition 270 may comprise an outer metal casing (also known as an “armature”), which is formed by two partitions between which a cooling fluid, such as water, flows (wall called “water jacket”).

In other words, the vertical partition 270 is configured to create an opening at the bottom of the furnace 200, so that the molten material in the first heating zone Z_1 can flow towards the second heating zone Z_2, and then be discharged from the furnace 200.

It should be noted that the ability of the partition 270 (due to its adapted height) to block, at the surface of the bath of molten materials 220, the circulation of molten materials between the zones Z_1, Z_2 advantageously prevents foam generated in the second heating zone Z_2 from migrating to the first heating zone Z_1. In other words, the presence of the vertical partition 270 further optimizes the heating efficiency of the hybrid furnace 200.

As mentioned previously, it is possible to envisage the melting energy used in the first zone Z_1 being solely combustion energy (that is, share of combustion energy=100%). Such arrangements are advantageous in the context of this embodiment in that they promote the creation of convection movements in the bath 220 to help circulate molten materials between the first and second zones Z_1, Z_2 at the hearth 211 of the furnace 200.

When the furnace 200 comprises a fume exhaust chimney similar to that 180 shown in FIG. 1, the vertical partition 270 is then provided at the top with at least one opening (not shown) to allow said fumes to flow from the first heating zone Z_1 to the second heating zone Z_2, as far as said exhaust chimney arranged downstream.

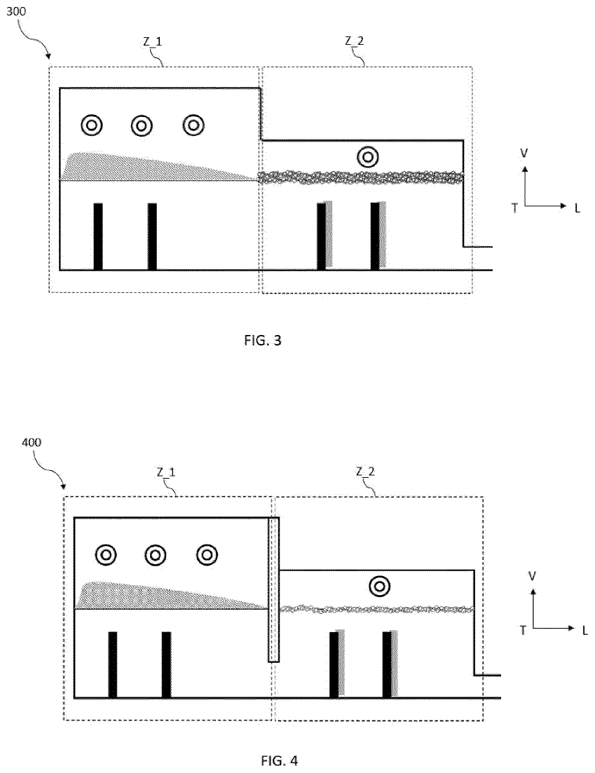

FIGS. 3 and 4 schematically shown, in its environment, other particular embodiments of glass furnaces 300, 400 according to the invention.

In particular, the furnace 300 (respectively the furnace 400) differs from the furnace 100 in FIG. 1 (respectively the furnace 200 in FIG. 2) in that the crown height in the second heating zone Z_2 is lower than the crown height in the first heating zone Z_1.

The hybrid furnace according to the invention has also been described so far on the basis that the bath height in the first zone Z_1 is identical to the bath height in the second zone Z_2. Such arrangements do not, however, limit the invention, and nothing precludes the consideration of embodiments wherein the bath height in the second zone Z_2 is lower than the bath height in the first zone Z_1. While there is such a difference in bath height between zones Z_1 and Z_2, the minimum bath height in the second zone Z_2 can, for example, be between 200 mm and 300 mm.

Having a lower glass height in the second zone Z_2 advantageously reduces furnace construction costs, as the amount of refractory material is minimized. In addition, energy requirements are minimized, as the volume of glass to be heated is reduced by minimizing heat loss through the refractory walls.

Preferably, when the bath height in the second zone Z_2 is lower than the bath height in the first zone Z_1, the melting energy used in the second zone Z_2 is solely electrical energy, which may enable the second zone Z_2 to be designed with a crown whose height is flush with the bath surface.

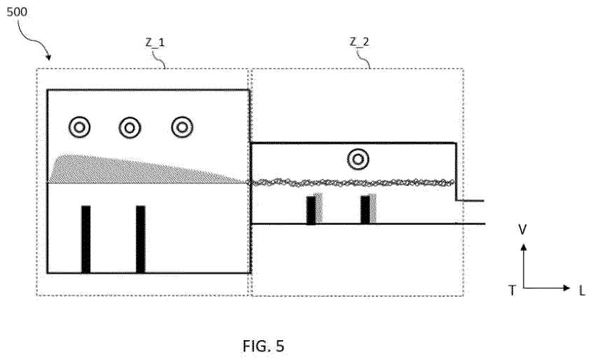

In a non-limiting fashion, FIG. 5 schematically shows another embodiment of a hybrid glass furnace 500 according to the invention, wherein the bath height in the second zone Z_2 is lower than the bath height in the first zone Z_1. As can be seen in FIG. 5, the height of the furnace hearth 500 differs between zones Z_1 and Z_2, so that the desired difference in bath heights can be achieved in this embodiment.

According to yet another aspect, the invention also covers a glass manufacturing method (not shown in detail by the figures) which, in addition to the step of melting the vitrifiable materials, comprises for example a step of final shaping of the glass which may be preceded, according to more particular exemplary embodiments, by steps of refining and/or homogenization and/or thermal conditioning from the molten material which flows out of the tank.

1. A method for manufacturing glass, comprising melting vitrifiable materials that are intended for the manufacture of said glass, said vitrifiable materials containing a proportion of carbon-containing organic matter of between 0.5% and 10%, wherein the melting of the vitrifiable materials is implemented by means of a hybrid glass furnace comprising a hot-top tank, said tank comprising, from upstream to downstream:
a first heating zone comprising combustion heating means,
a second heating zone comprising electrodes immersed in the bath of molten materials,
said melting being implemented such that a proportion of combustion energy used for melting vitrifiable materials in the first zone is at least 50% and a proportion of electrical energy used for melting vitrifiable materials in the second zone is at least 50%, prioritizing the use of the combustion energy in the first heating zone in order to limit foaming in said first heating zone and, conversely, the use of the electrical energy in the second heating zone so as to maximize the heating efficiency of each of said energies used in the furnace.

2. The method according to claim 1, wherein the proportion of combustion energy used in the first zone is at least 70%.

3. The method according to claim 2, wherein the melting energy used in the first zone is solely combustion energy.

4. The method according to claim 1, wherein the first heating zone further comprises electrodes immersed in the bath of molten materials, the melting is implemented so that the proportion of electrical energy used in the first zone enables the bath temperature there to be maintained above a given temperature.

5. The method according to claim 1, wherein the proportion of electrical energy used in the second zone is at least 70%.

6. The method according to claim 5, wherein the melting energy used in the second zone is solely electrical energy.

7. The method according to claim 1, wherein the second heating zone further comprises combustion heating means, the melting being implemented in such a way that the proportion of combustion energy used in the second zone enables the temperature there of a crown to be maintained above a given temperature.

8. The method according to claim 1, wherein the proportion of combustion energy used in the first zone and the proportion of electrical energy used in the second zone are equal or different, one being greater than the other or vice versa.

9. The method according to claim 1, wherein the combustion energy in the first zone and/or in the second zone is obtained by hydrogen combustion.

10. The method according to claim 1, wherein the vitrifiable materials are chosen to enable the manufacture of borosilicate glass.

11. The method according to claim 1, wherein the proportion of carbonaceous organic matter contained in the vitrifiable materials, less than or equal to 10%, is between 0.75% and 10%.

12. The method according to claim 1, wherein the vitrifiable materials comprise recycled materials and/or mineral wool in a proportion less than or equal to 100%.

13. The method according to claim 1, wherein combustion fumes produced in the first heating zone are discharged towards the second heating zone as far as an exhaust chimney arranged downstream in said second heating zone so as to enable a temperature of a crown in said second heating zone to be maintained above a given temperature, by means of said fumes.

14. A hybrid glass furnace configured to implement the method for manufacturing glass, according to claim 1, said furnace comprising a control unit for respectively controlling at least the combustion heating means in the first heating zone and the electrodes immersed in the bath of molten materials in the second heating zone on the basis of the proportion of carbonaceous organic matter contained in the vitrifiable materials, prioritizing the use of the combustion energy in the first heating zone in order to limit foaming in said first heating zone and, conversely, the use of the electrical energy in the second heating zone so as to maximize the heating efficiency of each of said energies used in the furnace.

15. The furnace according to claim 14, the furnace comprising a vertical partition configured to:
block the flow of melt between the first and second zones on the surface of the bath of molten materials,
allow melt to circulate between the first and second zones on the hearth of the furnace.

16. The furnace according to claim 14, wherein a crown height in the second heating zone is lower than a crown height in the first heating zone.

17. The furnace according to claim 14, wherein the bath height in the second heating zone is lower than the bath height in the first heating zone.

18. The furnace according to claim 14, the furnace further comprising an exhaust chimney which, arranged in a downstream portion of the second heating zone, is configured to discharge combustion fumes produced in the first heating zone to the second heating zone.

19. The method according to claim 4, wherein the given temperature is a glass devitrification temperature.

20. The method according to claim 7, wherein the given temperature is a sodium borate condensation temperature.
